(19) United States
(12) Patent Application Publication
(10) Pub. No.: US 2006/0076281 A1
(43) Pub. Date: Apr. 13, 2006

(54) Device for continuously filtering deep fat fryer oil

(75) Inventor: Rene Aldeguer, Mogneneins (FR)

Correspondence Address: OLIFF & BERRIDGE, PLC, P.O. BOX 19928, ALEXANDRIA, VA, 22320, US

(73) Assignee: MORICE EQUIPEMENT, Miribel (FR)

(21) Appl. No.: 11/168,871

(22) Filed: Jun. 29, 2005

(30) Foreign Application Priority Data
Oct. 7, 2004 (FR) 04.10594

(51) Int. Cl. B01D 35/00

(52) U.S. Cl. 210/167; 210/416.5; 210/DIG. 8

(57) ABSTRACT

For a deep fat fryer comprising a vat containing a bath of heated oil, there is provided a built-in device for filtering the oil, including means for collecting the oil contained in the vat, and means for pumping, for filtering and for recirculating this oil to the vat. The filtering device comprises, on the one hand, a filtering unit situated in the upper part of the vat of the deep fat fryer, in a readily accessible location, at the downstream end of the recirculating means and, on the other hand, arranged inside the cabinet of the deep fat fryer, a motor and a pump, particularly a rotary pump, driven by the motor. The invention applies to industrial or commercial deep fat fryers.

### BACKGROUND OF THE INVENTION

The present invention relates in general to appliances for cooking using a heated oil bath, of the deep fat fryer kind, and its subject is more particularly a filtering device for continuously filtering the oil used for cooking, that is to say a filtering device that operates permanently and at the same time as the deep fat fryer. The invention also relates to a filtering unit specially intended for this filtering device for continuously filtering deep fat fryer oil.

This invention applies in particular to industrial or commercial deep fat fryers such as those used in the kitchens of restaurants and communities.

### DESCRIPTION OF THE PRIOR ART

The systems customarily used for filtering the oil of such industrial or commercial deep fat fryers are generally complicated and expensive.

Usually, these are systems external to the deep fat fryer and produced in the form of an independent filtering trolley with a filter that has to be coupled periodically to the oil discharge of the deep fat fryer, when the latter is shut down. The oil extracted from the deep fat fryer is then filtered through the trolley then returned by recirculation to the vat containing the oil bath of the deep fat fryer. This operation of filtering the oil is usually performed once or twice per week, depending on the duty of the deep fat fryer. Each filtering operation is performed hot, with the oil still at a temperature of about 150° C., after waiting a certain length of time after shutting down the deep fat fryer. By way of example of such an oil filtering system, produced in the form of a trolley, reference is made to U.S. Pat. No. 4,945,893 (including the state of the art set out in the introductory part of that patent).

More rarely, the deep fat fryers comprise a built-in system for filtering and recirculating the oil with a filter and a pump. The use of such a system generally entails shutting down the deep fat fryer, which means that this use is, out of necessity, intermittent or periodic, for example after each sitting. By way of examples of such filtering systems that are used periodically, reference is made to U.S. Pat. Nos. 4,195,667 and 4,328,097.

In the preceding two cases, in order to perform the operations of filtering the oil in a relatively acceptable length of time, that is to say in a few minutes, for a volume of oil of the order of 20 to 25 liters which is to be filtered, it is necessary to use powerful, and therefore bulky and expensive, pumps.

In addition, the periodic nature of the filtering of the oil leads to a degradation of the quality of this oil, from the moment it has just been filtered right up to the time of the next filtering operation.

Finally, deep fat fryers provided with a device for continuously filtering the oil have already been proposed, dispensing with the need to shut down the deep fat fryer in order to filter the oil. The device for continuously filtering the oil comprises, in this case, means for collecting the oil contained in the vat of the deep fat fryer, and means for pumping, for filtering and for recirculating this oil to the vat, this filtering device and, in particular, its oil pumping means, being designed to be actuated permanently, during the time in which the deep fat fryer is in use. Such devices for continuously filtering oil are described in U.S. Pat. No. 3,685,433 and in British Patent Application GB 2 307 650 A.

Practical embodiments of filtering devices which correspond to these stated documents comprise one or two filter tanks arranged below the vat of the deep fat fryer and a pump which can be immersed in a filter tank, or arranged in the oil circuit, for example, downstream of a filter tank. These embodiments are still relatively complicated and voluminous and therefore bulky, which means that building a device for the continuous filtering of the oil into the cabinet of a deep fat fryer still presents difficulties. In addition, the use of filter tanks makes the operations of cleaning and replacing the filter elements fairly difficult.

Also known, for example from U.S. Pat. No. 4,068,571, are devices for continuously filtering the oil of a deep fat fryer, which are produced such that they are less bulky than the preceding devices, particularly using an electric motor, a rotary pump and a filter element all arranged in line, in a compact arrangement allowing the complete filtering device to be built into the cabinet of a deep fat fryer.

However, in these stated embodiments, the filter elements are housed in casings which means that these filter elements are relatively difficult to clean or to replace. In particular, cleaning or replacing the filter elements entails disassembling or unscrewing parts or casings, which operations are particularly dirty especially when changing a filter. In this respect, consideration has also to be given to the fact that the filter, placed inside the cabinet of the deep fat fryer, is awkward to access.

### SUMMARY OF THE INVENTION

The present invention aims to avoid these difficulties and its object is therefore to provide a filtering device for continuously filtering oil for a deep fat fryer which is of a particularly simple and compact structure allowing it to be easily built into the cabinet of any industrial or commercial deep fat fryer while at the same time making the operations of cleaning and changing the filter easier by providing direct access to this filter.

To this end, the subject of the invention is a filtering device for continuously filtering deep fat fryer oil, particularly the oil of an industrial or commercial deep fat fryer, the deep fat fryer comprising a vat containing a bath of oil, and means for heating the oil bath, and the oil filtering device being a built-in device including means for collecting the oil contained in the vat and means for pumping, filtering and recirculating this oil to the vat, this filtering device being essentially characterized in that it comprises, on the one hand, a filtering unit situated in the upper part of the vat of the deep fat fryer, at a readily accessible location, at the downstream end of the recirculating means and, on the other hand, arranged inside the cabinet of the deep fat fryer, a motor and a pump, particularly a rotary pump, driven by the motor. The filtering unit thus has the characteristic of being separate from the motor and from the pump of the filtering device, and of being very readily accessible, even when the deep fat fryer is running.

According to one advantageous embodiment, the filtering unit comprises a removable filter element designed to filter the oil under gravity at the mouth of a return pipe returning the oil to the vat of the deep fat fryer, the return pipe being connected to an oil outlet of the body of the pump.

Thus, the filter element is very easy to change, without entailing disassembling the device, or draining it, or closing the valve.

The filter element is, for example, a filter made of microporous fabric, of food-grade quality, placed on a perforated support. It is possible to use a large-sized filter which therefore becomes saturated less quickly.

The filtering unit may also comprise a removable filter cover member, advantageously equipped with a handle.

This filtering unit may be held in place, in the upper region of the vat of the deep fat fryer, by any means, such as by two support studs for example, placed one facing the other inside the vat of the deep fat fryer, or a horizontal metal bar, particularly made of stainless steel, held at its two ends by two respective angle brackets.

It is also conceivable for a prefiltering element to be mounted in the lower part of the vat of the deep fat fryer, at the mouth of a pipe conveying oil from the vat to an oil inlet of the body of the pump. Thus, the oil is prefiltered before being directed to the pump, and this prevents the passage, upstream of the pump, of large pieces of residue such as whole French fries, the blocking or build-up of which could slow the flow of oil. This prefiltering element may be produced in the form of a simple roundel provided with openings of appropriate sizes.

A shut-off valve is advantageously placed on the conveying pipe and designed to control the arrival of oil in the pump; the shut-off value is closed before any operation of draining the settling pot so as to eliminate the collected waste.

An oil settling pot may be fixed removably to the pump and preferably provided with a drain valve thus making it possible to eliminate the residue that has built up in the settling pot, and thereby reduce the frequency with which the filter element has to be cleaned.

Finally, provision is advantageously made for the motor driving the pump, particularly the rotary pump, to be a motor switched on automatically as soon as the means for heating the oil bath are switched on, and for this motor to be switched off again automatically at the same time as the deep fat fryer.

In its entirety, the invention thus proposes a filtering device for continuously filtering the oil of a deep fat fryer, that is to say a device which operates throughout the service life of the deep fat fryer, the oil being filtered in closed circuit, within the deep fat fryer. This continuous filtering device and the deep fat fryer equipped therewith, exhibit the following advantages:

The oil in the bath of the deep fat fryer is permanently filtered, as soon as the deep fat fryer is switched on, and this cleans and regenerates it constantly (with an intake of oxygen) and extends its service life, unlike the conventional systems with which the oil degrades between two successive filtering operations, and this has the following advantageous consequences:
better hygiene conditions,
the fried food has a better flavor,
it results in a saving on oil, the service life of the oil baths being extended.

Still as a result of its continuous operation, the oil filtering device according to the invention may be able to restrict itself to a low output pump for circulating the oil through the filtering circuit. It is thus possible to use a miniaturized low-cost pump.

In addition, the overall design of the filtering device according to the invention dispenses with the need for any bulky filter tank.

Thus, this continuous filtering device is of a simple and economical structure and is discrete and compact by comparison with the current systems which are bulky and expensive.

The continuous filtering device proposed can be fitted to any deep fat fryer of an existing or future model, or be adapted without difficulty to suit a pre-existing deep fat fryer.

In addition, slaving the operation of this continuous filtering device to that of the deep fat fryer ensures that it will definitely and permanently be in operation, there being no gesture required in order to switch it on.

Finally, the only actions still needed periodically, for cleaning the filtering unit and replacing the filter element, remain simple, quick, safe and relatively clean by comparison with the devices known earlier, this being because of the position and structure of the filtering unit.

Use therefore, on the whole, remains very practical.

Another subject of the invention is, as such, a filtering unit intended for a filtering device for the continuous filtering of deep fat fryer oil as defined hereinabove, this filtering unit comprising a filter element designed to filter the oil by gravity, placed in a support part provided with retaining means, retaining particularly by hooking, for positioning it at the upper part of the vat of the deep fat fryer.

It thus consists of a filtering unit constructionally independent of the other components of the oil filtering device and directly accessible, it being possible for this filtering unit to be extracted and refitted instantly, with a filter element of food-grade quality that is washable and reusable, and which can also be replaced in a few seconds. Of course, when in place in the upper region of the vat, this filtering unit functionally collaborates with the other components of the filtering device, collecting and filtering the oil sent to the upper part of the deep fat fryer, through the recirculating pipe by the pump itself driven by the motor.

### BRIEF DESCRIPTION OF THE DRAWINGS

The invention will be better understood from the description which follows, with reference to the attached schematic drawing depicting, by way of example, one embodiment of this filtering device for continuously filtering oil for a deep fat fryer, and embodiments of its filtering unit:

FIG. 1 is a block diagram of the filtering device for continuously filtering oil according to the present invention, and fitted to a deep fat fryer;

FIG. 2 is an exploded perspective view of the oil filtering unit of this device;

FIG. 3 is a perspective general view of the oil pumping means of this device;

FIG. 4 is a detailed view in longitudinal section of the oil pumping means of this device;

FIG. 5 is an exploded perspective view showing a first embodiment of the means holding the filtering unit in place;

FIG. 6 is a view in cross section showing the filtering unit held in place by the means of FIG. 5;

FIG. 7 is an exploded perspective view showing a second embodiment of the means holding the filtering unit in place;

FIG. 8 is an exploded perspective view of the prefiltering element.

### DESCRIPTION OF THE PREFERRED EMBODIMENTS

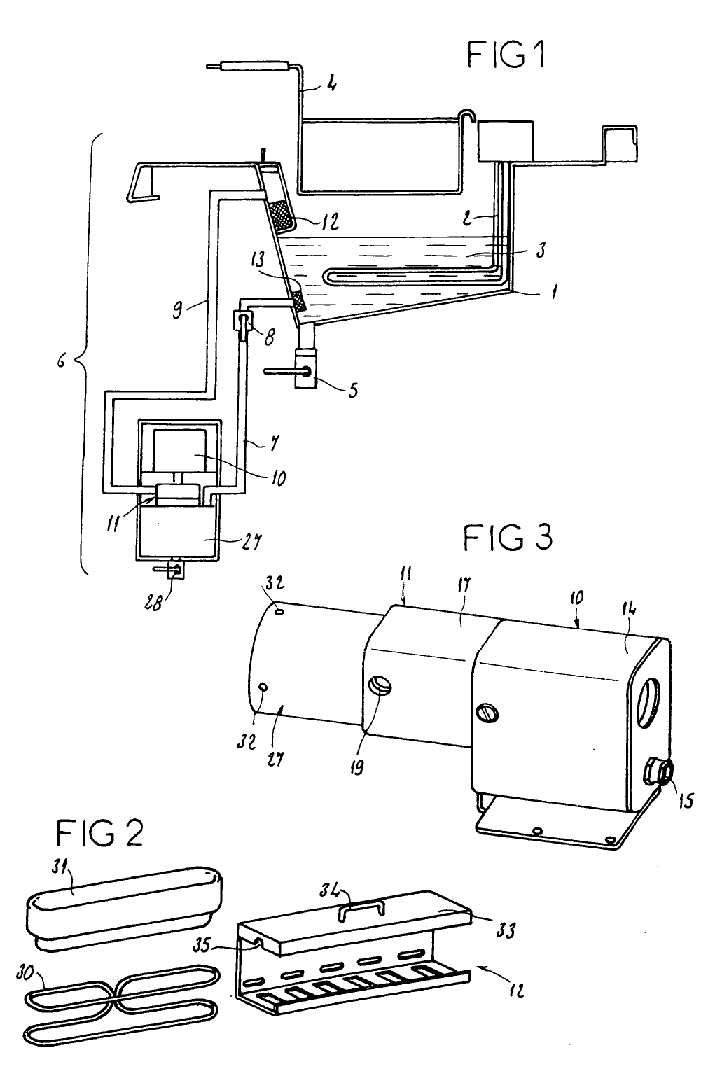

As recalled in FIG. 1, an industrial or commercial deep fat fryer comprises, in a way generally known, a vat 1 open at its top and designed to contain an oil bath 3, and a removable basket 4 for containing the food that is to be fried. Heating means 2, particularly electrical heating means, are provided for heating the oil bath 3 and keeping it at temperature. A drain device 5, with a valve, is provided at the lowermost point of the vat 1 of the deep fat fryer.

This deep fat fryer is equipped with a device for continuously filtering the oil, denoted overall by the reference 6. This filtering device 6 comprises, in particular, a motor/pump unit arranged horizontally inside the cabinet of the deep fat fryer with a rotary pump 11 driven by an electrical motor 10 and a filtering unit 12 situated at the upper part of the vat 1 of the deep fat fryer.

A conveying pipe 7 conveys oil from the vat 1 to the filtering device 6. Its mouth lies in the lower third of the vat 1 of the deep fat fryer and comprises a prefiltering element 13 that can be washed without removing it, simply by brushing (see more detailed description hereinafter).

A shut-off valve 8, provided to control the arrival of oil at the filtering device 6, is placed in the conveying pipe 7 upstream of the inlet to the motor/pump unit 10-11.

A return pipe 9 has its starting point at the outlet of the motor/pump unit 10-11 and returns to the vat 1, opening into the upper region thereof, that is to say above the maximum oil level of this vat 1, above the filtering unit 12.

As illustrated in FIG. 2, the filtering unit 12 comprises a filter element 31 designed to capture the oil as it returns to the vat 1 and filter it under gravity. The filter element is a technical filter 31 made of microporous fabric, of food-grade quality, placed on a perforated stainless steel wire support 30, the whole being protected by a removable stainless steel filter cover member 33 equipped with a handle 34. The filter 31 allows fine filtration (30 to 50 microns) of the frying oils. It is washable and reusable.

The filtering unit 12 is mounted in a dedicated and readily accessible space, in the upper part, above the maximum oil level of the vat 1. The filter 31 is positioned below the mouth of the return pipe 9 into the vat 1 so that the oil is filtered under gravity, passing vertically through the filter 31, before dropping back down into the vat 1. The means for holding this filtering unit 12 in place may adopt various forms, and examples thereof will be given hereinafter with reference to FIGS. 5 to 7.

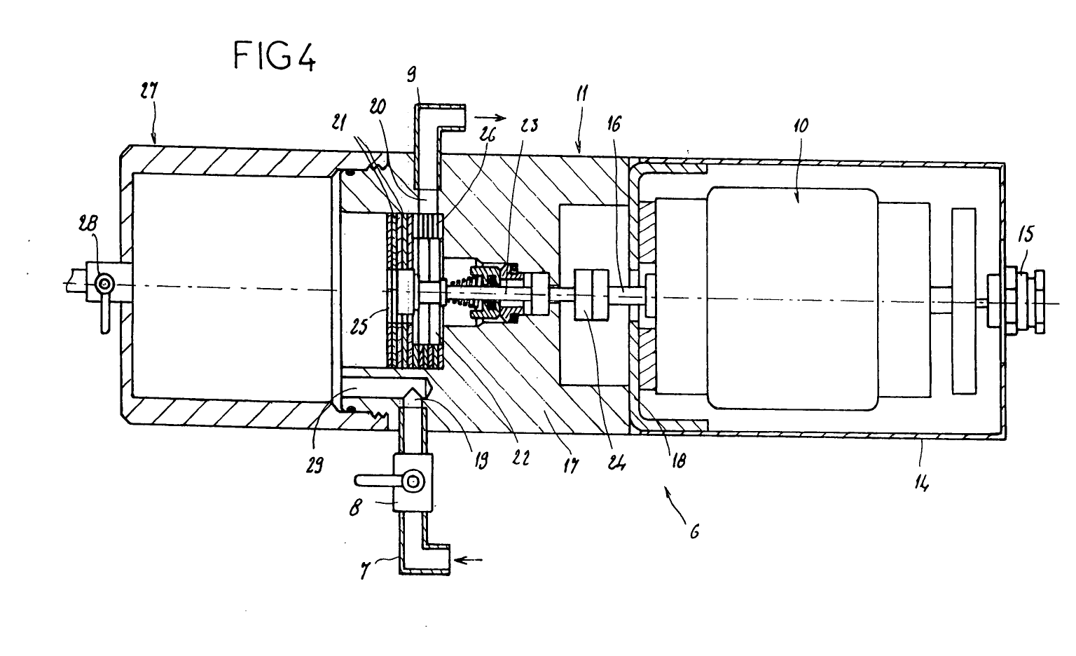

The motor/pump unit of the filtering device 6, namely the motor 10, the pump 11 and a settling pot 27, is depicted in greater detail in FIGS. 3 and 4.

The motor 10 is an electric motor, mounted under a hood 14 equipped with a sealed penetration 15 for the passage of the electric supply cables. The motor 10 comprises a horizontal shaft 16, directed forward.

The pump 11 is a pump of the centrifugal type, the body 17 of which is placed in front of the motor 10, with the interposition of a connecting plate 18 for connecting the motor 10 and the pump 11. The body 17 of the pump 11 possesses a lateral oil inlet 19 and a lateral oil outlet 20. The oil inlet 19 is coupled to the end of the conveying pipe 7, downstream of the valve 8. The oil outlet 20 is coupled to the start of the oil return pipe 9, which may adopt the form of an elbow coupling.

The pump 11 has, in its body 17, a cavity, for example delimited by a stack of cut plates 21, some of which are hollowed out at their center. Mounted so that it can rotate in the pump cavity thus formed is an impeller 22, borne by a spindle 23 mounted to rotate in rolling bearings. A coupling 24 provides the driving connection between the shaft 16 of the electric motor 10 and the spindle 23 of the impeller 22.

The end plates 21 that delimit the cavity of the pump 11 have at least one central intake opening 25. The other plates 21, situated around the impeller 22, have interruptions 26 in the tangential direction, forming a delivery opening which is extended by the lateral oil outlet 20 in the pump body 17.

A settling pot 27 is screwed in a sealed fashion under the pump body 17 and delimits a chamber extending from the closed end of this settling pot 27 as far as the intake opening 25 of the pump 11. The lateral oil inlet 19 of the pump body 17 is extended by an internal duct 29 which opens into the chamber of the settling pot 27.

In order to limit the operations involved in cleaning the filter 31, a drain valve 28 is mounted under the settling pot 27. It allows the residue that builds up in the settling pot 27 to be removed and also makes it possible to avoid oil solidifying in the pipes 7 and 9.

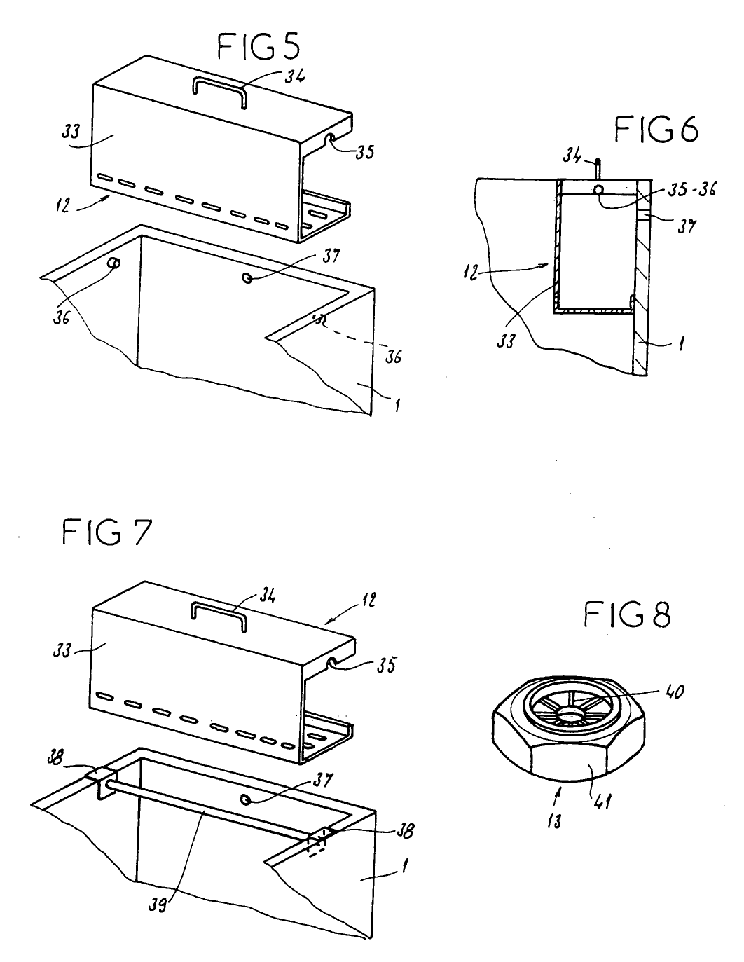

FIGS. 5 and 6 illustrate, in detail, a first embodiment of the means for holding in place the filtering unit 12, for which only the filter cover 33 is depicted here. The latter is provided, in its upper part and at its two ends, with two downwardly facing notches 35. The upper part of the vat 1 of the deep fat fryer comprises, on two opposite lateral faces, two support studs 36 placed one facing the other. The filtering unit 12 can thus be hooked, via its ends, onto the two studs 36 by engaging and hooking each notch 35 onto one of the studs 36, so that the filtering unit 12 is held horizontally, along one of the sides of the vat 1 in the upper part thereof, facing the mouth 37 of the return pipe 9 returning the oil to the vat 1. This first embodiment is more particularly suited to a deep fat fryer equipped from the outset with the filtering device 6 that forms the subject of the invention.

FIG. 7 illustrates a second embodiment of the means for holding the filtering unit 12 in place. The latter here is provided again with notches 35. Two angle brackets 38, fixed to the upper edge of the vat 1, and two opposite sides thereof, hold the two ends of a metal rod 39, particularly made of stainless steel, which thus extends horizontally across the upper part of the vat past the mouth 37 of the oil return pipe. The filtering unit 12 hooks via its two notches 35 onto the rod 39. This other embodiment is more particularly suited to a pre-existing deep fat fryer which will be equipped later with the filtering device that is the subject of the invention.

As the drawing illustrates (compare FIGS. 1 and 6), the means previously described, for holding the filtering unit 12 in place, are appropriate both for a vat 1 with vertical walls and for vat 1 with walls that may have some degree of inclination.

Finally, FIG. 8 illustrates an embodiment of the prefiltering element 13. The latter comprises a roundel 40, mounted in a nut 41, the roundel 40 being provided with openings cut, in particular, in sectors of a circle. It will be noted that the total passage cross section resulting from all the openings in the roundel 40 is not smaller than the cross section of the conveying pipe 7 at the start of which the prefiltering element 13 is placed.

The filtering device 6 described previously is designed to operate permanently, while the deep fat fryer is in use, that is to say throughout the time that it is cooking food placed in the basket 4. Continuous operation of the filtering device 6 is ensured as follows, in relation to that of the deep fat fryer.

The hot oil in the oil bath 3, for example at a temperature of 180° C., is collected in the lower region of the vat 1, by the pipe 7, through the prefiltering element 13, which makes it possible to prevent the passage, upstream of the pump 11, of large items of residues such as whole French fries, a build-up or blockage of which could slow the flow of oil.

The prefiltered oil thus reaches the lateral inlet 19 of the pump body 17 and is directed, via the duct 29, to the settling pot 27.

The settled oil is drawn up, through the central intake opening 25, into the cavity of the pump 11 which delivers it through the tangential opening resulting from the interruptions 26 then through the lateral outlet 20.

The oil is returned by the duct 9, then filtered under gravity across the filter 31 of the filtering unit 12, before dropping back into the vat 1 of the deep fat fryer. The oil is thus filtered and recirculated permanently.

The impeller 22 of the pump 11 is capable of grinding small items of debris, of the carbonated residue kind, which is then filtered without blocking the circuit downstream of the pump 11 because it is collected on the filter 31: the circulation of waste is therefore not “looped back”.

The operation described hereinabove of the filtering device 6 is automatically slaved to that of the deep fat fryer: as soon as the deep fat fryer is switched on, that is to say as soon as the oil bath 3 is heated, the motor 10 is also automatically switched on so that the filtering of the oil begins, and this filtering continues until the deep fat fryer is shut down.

It is also possible, during a period for which the deep fat fryer is shut down and after the valve 8 has been closed, to unscrew the settling pot 27 of the pump 11 to empty out the collected waste. A simple tool, of the wrench type, is advantageously provided to assist with removing and refitting the settling pot 27, this tool grasping the settling pot 27 in collaboration with one of many blind holes 32 formed in the base of this settling pot 27 (see FIG. 3).

In a variant that has not been illustrated, the settling pot 27 can be unscrewed using a hexagon head with which the settling pot is equipped on its end face.

Any variant of the following in particular would not constitute a departure from the scope of the invention as defined in the attached claims:
the constructional details of the filtering device, particularly of its pump, it being possible for the latter to be of any type;
the filtering materials used, and the design of the filter and of the prefilter;
the means used for holding the filtering unit in place in the upper region of the vat of the deep fat fryer;
the position and orientation of the motor/pump unit within the cabinet of the deep fat fryer.

1. A filtering device for continuously filtering deep fat fryer oil, particularly the oil of an industrial or commercial deep fat fryer, the deep fat fryer comprising a vat containing a bath of oil, and means for heating the oil bath, and the oil filtering device being a built-in device including means for collecting the oil contained in the vat and means for pumping, filtering and recirculating this oil to the vat, which device comprises, on the one hand, a filtering unit situated in the upper part of the vat of the deep fat fryer, at a readily accessible location, at the downstream end of the recirculating means and, on the other hand, arranged inside the cabinet of the deep fat fryer, a motor and a pump, particularly a rotary pump, driven by the motor.

2. The filtering device as claimed in claim 1, wherein the filtering unit comprises a removable filter element designed to filter the oil under gravity at the mouth of a return pipe returning the oil to the vat of the deep fat fryer, the return pipe being connected to an oil outlet of the body of the pump.

3. The filtering device as claimed in claim 2, wherein the filter element is a filter made of microporous fabric, of food-grade quality, placed on a removable perforated support.

4. The filtering device as claimed in claim 2, wherein the filtering unit comprises a removable filter cover member advantageously equipped with a handle.

5. The filtering device as claimed in claim 1, wherein a prefiltering element is mounted in the lower part of the vat of the deep fat fryer, at the mouth of a pipe conveying oil from the vat to an oil inlet of the body of the pump.

6. The filtering device as claimed in claim 5, wherein a shut-off valve is placed on the conveying pipe and designed to control the arrival of oil in the pump.

7. The filtering device as claimed in claim 1, wherein an oil settling pot is fixed removably to the pump and is preferably provided with a drain valve.

8. The filtering device as claimed in claim 1, wherein the motor driving the pump, particularly the rotary pump, is a motor switched on automatically as soon as the means for heating the oil bath are switched on, and wherein this motor is switched off again automatically at the same time as the deep fat fryer.

9. A filtering unit intended for a filtering device for the continuous filtering of deep fat fryer oil as claimed in claim 1, and which comprises a filter element designed to filter the oil by gravity, placed in a support part provided with retaining means, retaining particularly by hooking, for positioning it at the upper part of the vat of the deep fat fryer.

10. The filtering unit as claimed in claim 9, of which the retaining means consist of two downwardly-facing notches designed to hook onto studs or onto a rod which are placed in the upper part of the vat of the deep fat fryer.
